(19) United States
(12) Patent Application Publication
(10) Pub. No.: US 2003/0231726 A1
(43) Pub. Date: Dec. 18, 2003

(54) Arrangement and method for frequency domain compensation of OFDM signals with IQ imbalance

(76) Inventors: Andreas Schuchert, Muenchen (DE); Martin Buchholz, Tournefeuille (FR); Ralph Hasholzner, Muenchen (DE)

Correspondence Address: MOTOROLA INC, AUSTIN INTELLECTUAL PROPERTY, LAW SECTION, 7700 WEST PARMER LANE MD: TX32/PL02, AUSTIN, TX, 78729

(21) Appl. No.: 10/271,620

(22) Filed: Oct. 15, 2002

(30) Foreign Application Priority Data
Jun. 12, 2002 (EP) 02291457.6

(51) Int. Cl. H04B 1/10

(52) U.S. Cl. 375/350

(57) ABSTRACT

An arrangement (600) and method for frequency domain compensation of OFDM signals with IQ imbalance by converting IQ signals to the frequency domain (610); and providing imbalance compensation and channel equalization means (620) and therewith, in the frequency domain, compensating for IQ imbalance in the IQ signals and providing channel equalization thereto. Adaptive equalization is used to adapt filter coefficients, allowing IQ imbalance compensation and channel equalization to be achieved simultaneously in a simple and elegant manner.

This allows complexity in analog circuitry and associated costs to be reduced at the expense of additional digital signal processing, yielding an overall economic system solution. The invention can be easily applied to existing systems, such as the DVB-T standard, without requiring changes to installed broadcasting infrastructure in order use receivers incorporating the invention.

### FIELD OF THE INVENTION

This invention relates to telecommunications systems, and particularly wireless or wireline systems employing orthogonal frequency division multiplexing (OFDM) multicarrier modulation.

### BACKGROUND OF THE INVENTION

In the field of this invention it is known that analogue IQ (In-phase and Quadrature-phase) modulators and demodulators tunable over a large frequency range (for example, the VHF/UHF bands from approximately 50 MHz to 860 MHz) are not exactly orthogonal and therefore introduce amplitude and phase imbalances (generally called IQ imbalances) distorting transmitted signals.

Prior art in this field falls into two different classes:

Single Carrier Transmission Systems

Distortions from IQ imbalances are detected and compensated by means of additional signal processing. Due to the very nature of single carrier transmission systems, the compensation always takes place in the time domain. It is known, from U.S. Pat. No. 5,949,821 and from the paper entitled “Adaptive Compensation for Imbalance and Offset Losses in Direct Conversion Transceivers” in IEEE Trans. Veh. Technol., Vol. 42, No. 4, pp. 581-588, November 1993, to employ a feed-forward structure. It is also known, for example from U.S. Pat. No. 5,396,656, to employ a feedback structure for compensation. In contrast, it is also known, for example from U.S. Pat. No. 5,105,195, to derive an error signal in the frequency domain (i.e., after a Fast Fourier Transform—FFT—operation), although compensation itself is performed in the time domain.

All these prior proposals have in common that the functionality to detect and compensate IQ imbalances must be implemented in addition to, and separate from, an equalizer removing linear distortions from the transmission channel.

Multicarrier Transmission Schemes

Due to the very nature of OFDM, most signal processing is done in the frequency domain. In conventional equalizer structures, for example from the paper entitled “Transmission Techniques for Digital Terrestrial TV Broadcasting” in IEEE Communications Magazine, February 1995, pp. 100-109, linear distortions from transmission channels are removed in the equalizer by multiplying received symbols on each subcarrier with appropriate coefficients derived from the estimated channel transfer function. The channel transfer function may be estimated by means of pilot subcarriers embedded in the transmitted signal, as known for example from the publication “Channel Estimation Units for an OFDM System suitable for Mobile Communication” by F. Classen, M. Speth, H. Meyr in ITG-Fachbericht 135 Mobile Kommunikation, VDE-Verlag, Germany, September 1995, pp. 457-466.

However, these known approaches have the disadvantages that:

1. the IQ imbalance compensation schemes for single carrier transmission do not exploit the frequency domain characteristics of OFDM signals allowing for simultaneous equalization of linear distortions from the transmission channel and compensation of distortions from IQ imbalances.

2. conventional frequency domain equalizers for OFDM transmission can not compensate for distortions caused by IQ imbalances.

A need therefore exists for frequency domain compensation for OFDM signals with IQ imbalance wherein the abovementioned disadvantages may be alleviated.

### STATEMENT OF INVENTION

In accordance with a first aspect of the present invention there is provided an arrangement for frequency domain compensation of OFDM signals with IQ imbalance, the arrangement comprising:

FFT means for converting IQ signals to the frequency domain; and

imbalance compensation and channel equalization means for, in the frequency domain, compensating for IQ imbalance in the IQ signals and providing channel equalization thereto.

In accordance with a second aspect of the present invention there is provided a method for frequency domain compensation of OFDM signals with IQ imbalance, the method comprising:

converting IQ signals to the frequency domain; and

providing imbalance compensation and channel equalization means and therewith, in the frequency domain, compensating for IQ imbalance in the IQ signals and providing channel equalization thereto.

### BRIEF DESCRIPTION OF THE DRAWINGS

One frequency domain compensation scheme for OFDM signals with IQ imbalance incorporating the present invention will now be described, by way of example only, with reference to the accompanying drawings, in which:

FIG. 1 is a block schematic diagram of a digital television system, complying with the European DVB-T standard, in which the present invention may be used;

FIG. 2 is a block schematic diagram of a prior art analogue IQ down-converter;

FIG. 3A, FIG. 3B and FIG. 3C are block schematic diagrams of prior art IQ demodulator arrangements for combating IQ imbalance;

FIG. 4 is a block schematic diagram illustrating a prior art OFDM demodulator;

FIG. 5 is a block schematic diagram illustrating an IQ demodulator arrangement providing imbalance detection and compensation together with channel equalization in accordance with the invention;

FIG. 6 is a block schematic diagram illustrating a OFDM demodulator, employing extended adaptive equalization, used in the IQ demodulator arrangement of FIG. 5; and

FIG. 7 is a block schematic diagram of a coefficient adaption arrangement for adapting filter coefficients for use in the OFDM demodulator of FIG. 6.

### DESCRIPTION OF PREFERRED EMBODIMENT

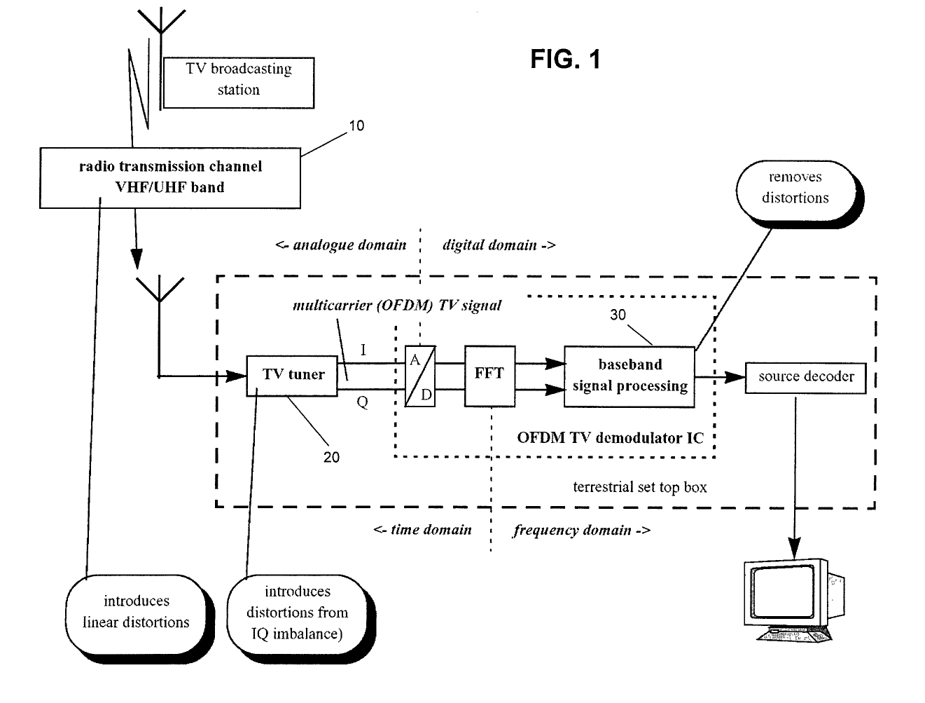

Referring firstly to FIG. 1, the European DVB-T standard for terrestrial transmission of digital TV signals in the VHF and UHF bands (approx. 50-860 MHz) employs the well known OFDM (orthogonal frequency division multiplexing) multicarrier modulation scheme with frequency domain equalization (at baseband signal processing stage 30) to counteract adverse characteristics of wireless transmission channels (linear distortions introduced by VHF/UHF band radio channel transmission at stage 10). Advantageous tuner concepts aiming at increased levels of system integration and multi-standard support simplify the architecture of consumer digital TV receivers, and consequently help to reduce manufacturing costs. In these tuner concepts directed towards direct conversion architectures, IQ demodulation is performed in the analogue domain (at TV tuner stage 20). However, imperfections in the analogue downconversion process lead to unequal gain in the two branches (I and Q) carrying the signal after downconversion. In addition, orthogonality of the cos and sin downconverters is lost to some extent. These amplitude and phase imbalances, generally referred to as IQ imbalances in the following description, introduce distortions to digital TV signals. Broadband systems, like digital TV, require bandwidth efficient high-order signal constellations, e.g., 64-QAM (Quadrature Amplitude Modulation), and are very sensitive with respect to distortions from IQ imbalances. Therefore, in the past, it was required that TV tuners introduce only negligible distortions by IQ imbalance to TV signals. The advantageous tuner concepts mentioned above could not be employed. Due to extremely high frequency range of the VHF and UHF bands, they are subject to severe IQ imbalances.

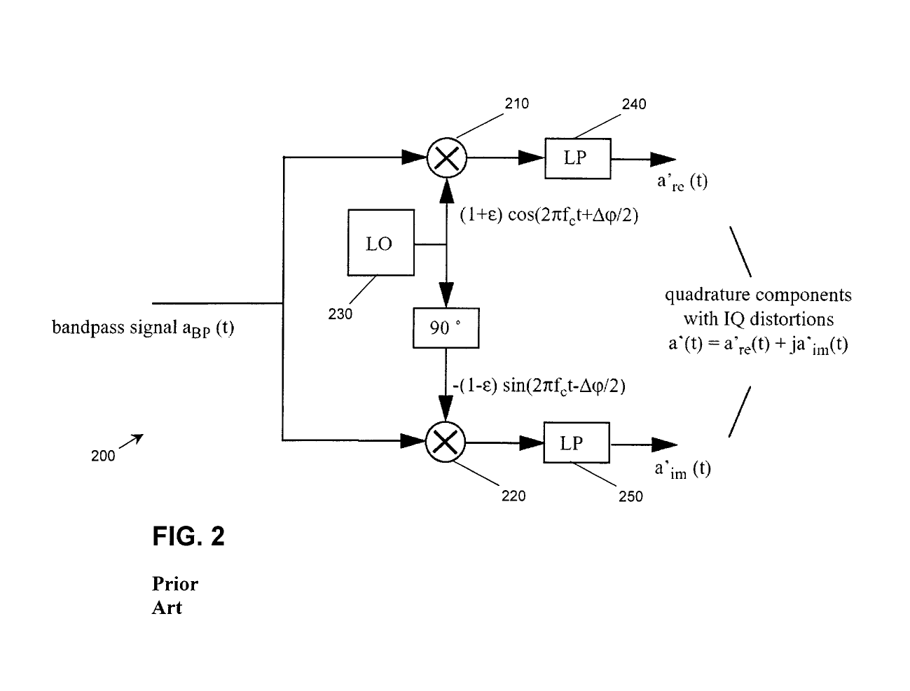

Referring now also to FIG. 2, an analogue IQ downconverter 200, consisting of a quadrature mixer 210 & 220, an oscillator 230, a variable gain amplifier (VGA not shown) and lowpass filtering 240 & 250 should be designed in such a way that the I and Q branch (baseband quadrature components) are identical both in electrical design and physical construction: there should be no gain or phase imbalance between the two channels. In practice, due to technological imperfections, analogue IQ downconverters show a mismatch of the quadrature branches in amplitude and phase. The signal model in FIG. 2 illustrates the amplitude error ε and the phase error Δφ caused by the imperfections in the downconversion process. In the context of OFDM the (frequency dependent) mismatch can be described in the frequency domain by a complex scaling of the wanted subcarrier A[k] and an emergence of an image frequency interferer A*[−k] which superposes the wanted subcarrier located at this image position. The resulting distorted signal A′[k]=FT{a′(t)} at frequency index k can be linearly decomposed, by the original signal A[k]=FT{a(t)} and a conjugate complex image component A*[−k], to

A′ᵢ[k]=μAᵢ[k]+νA*ᵢ[−k]

where the distortion parameters ε and ν are related to the imbalance errors ε and Δφ by

μ=cos(Δφ/2)−jε sin(Δφ/2)

ν=ε Cos (Δφ/2)+j sin(Δφ/2)

With respect to minimum bit error rates there are strong requirements for the accuracy of the signal complex amplitudes when higher order constellations like 64-QAM are being transmitted. In order to ensure reliable signal detection, all kinds of signal distortions are to be removed before the symbol decision takes place.

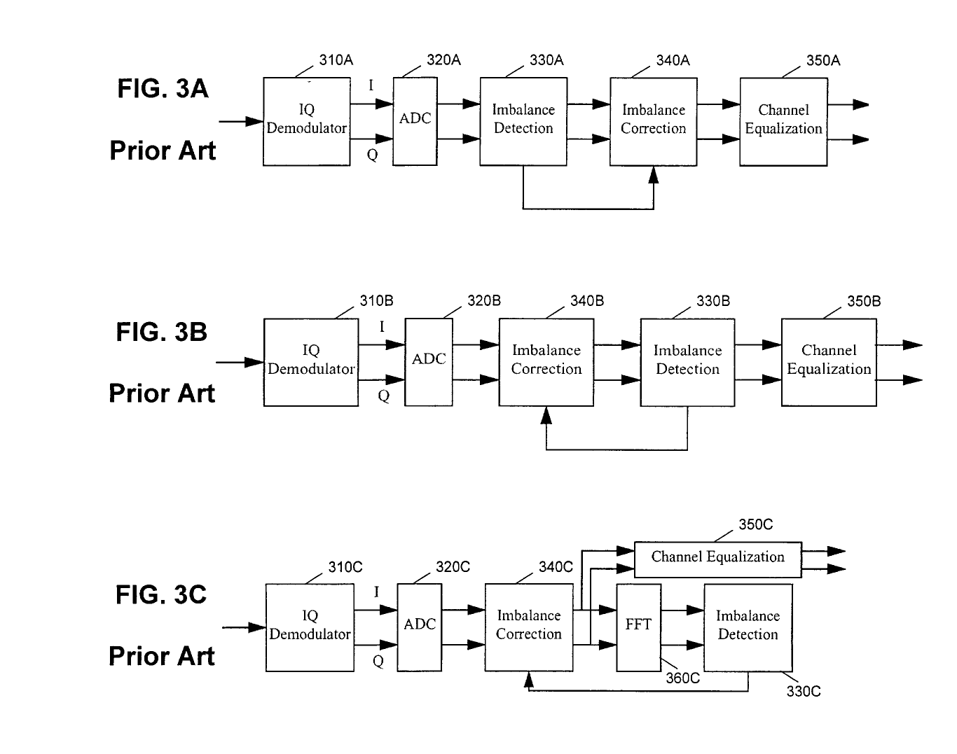

FIG. 3A, FIG. 3B and FIG. 3C summarize prior art known for combating IQ imbalance. The arrangement of FIG. 3A includes an IQ demodulator 310A, an analogue-to-digital converter 320A, an imbalance detection stage 330A, an imbalance correction stage 340A and a channel equalization stage 350A. The arrangement of FIG. 3B includes an IQ demodulator 310B, an analogue-to-digital converter 320B, an imbalance correction stage 340B, an imbalance detection stage 330B and a channel equalization stage 350B. The arrangement of FIG. 3C includes an IQ demodulator 310C, an analogue-to-digital converter 320C, an imbalance correction stage 340C, an FFT (Fast Fourier Transform) stage 360C, an imbalance detection stage 330C and a channel equalization stage 350C.

All these known proposals to combat IQ imbalance by digital signal processing have in common that the signal correction operates in the time domain regardless of whether the adjustment is done in a feedforward circuit as FIG. 3A (see U.S. Pat. No. 5,949,821 and from the paper entitled “Adaptive Compensation for Imbalance and Offset Losses in Direct Conversion Transceivers” in IEEE Trans. Veh. Technol., Vol. 42, No. 4, pp. 581-588, November 1993) or a feedback circuit such as FIG. 3B (see U.S. Pat. No. 5,396,656). It is also known from U.S. Pat. No. 5,105,195 to derive an error signal from the frequency domain such as in FIG. 3C, but in a completely different way since it is used for single carrier transmission with correction being carried out in the time domain. None of these known schemes is targeted to multicarrier transmission systems nor do they consider a common equalization of linear distortions and IQ distortions.

IQ imbalance between the I and the Q branch expresses in the frequency domain by a complex scaling of the desired frequency component and by an emergence of an interfering component at the image frequency. Related to an OFDM transmission system, where the subcarrier demodulation is done by a DFT (Discrete Fourier Transform) process with its circular indexing the desired frequency component is assumed at frequency index k. The interfering component then appears at the image frequency index N−k.

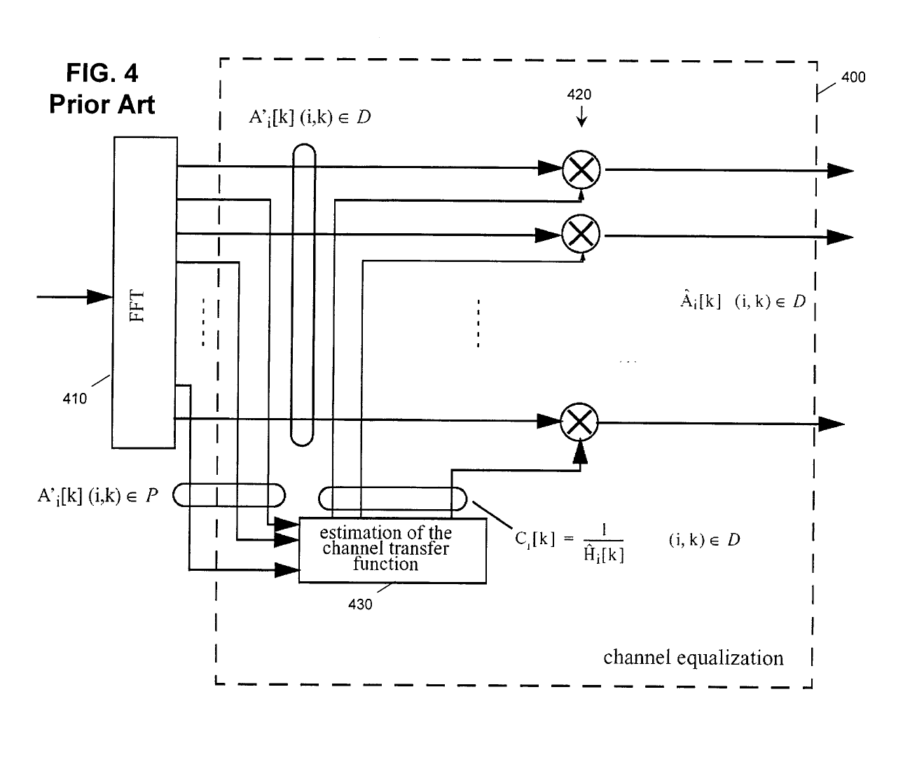

A conventional channel equalization stage 400, with the task to compensate linear channel distortions, is depicted in FIG. 4. The channel equalization stage 400 receives outputs A′ᵢ[k] from an FFT 410, and applies these outputs to respective complex multipliers 420. A channel transfer function estimator 430 derives, from the FFT outputs A′ᵢ[k] (e.g., by means of pilot subcarriers embedded in the transmitted signal), an estimate of the channnel transfer function, and produces coefficients Cᵢ[k]. The coefficients Cᵢ[k] are applied respectively to the complex multipliers 420 to produce output signals Âᵢ[k] which are equalized for linear distortions introduced from transmission channels.

This structure only takes into account the linearly distorted k^{th} subcarrier of the i^{th} OFDM-symbol A′ᵢ[k] and subjects it to a complex multiplication in order to generate an estimation Âᵢ[k] of the desired subcarrier, corrected in amplitude and phase. The appropriate filter coefficient Cᵢ[k] at index k has been previously determined by evaluation and interpolation of the pilot subcarriers in the estimation unit. The coefficients are the inverse of the estimated channel transfer function Ĥᵢ[k]. The correction is performed for each desired data subcarrier of the OFDM spectrum. This structure is only capable of removing linear distortions.

As will be described in more detail below, the present invention, at least in a preferred embodiment, implements a novel digital compensation scheme for IQ imbalance distortions in OFDM signals. A novel, extended adaptive frequency domain equalization network compensates distortions from IQ imbalances in analog tuners, and linear distortions from radio transmission channels at the same time. The novel tuner concepts mentioned above are also supported. The distortions are compensated by sophisticated digital base band processing using adaptive filtering. Signal processing operates on the frequency domain representation. It exploits special characteristics of OFDM signals, pilot tones embedded in the DVB-T stream and the efficient frequency domain equalization concept of OFDM demodulators. The compensation scheme can easily be modified for all other OFDM transmission schemes with interspersed pilot subcarriers (e.g., ISDB-T in Japan or WLAN) and will speed up the application of cost-effective receiver concepts.

The compensation scheme solves the IQ imbalance problem caused by inaccuracies in analogue RF quadrature demodulators (IQ demodulators) in combination with multicarrier transmission. Applied to data-aided (pilot-assisted) OFDM signal transmission the scheme compensates amplitude and phase imbalance generated in the analog downconversion process. If this kind of interference remains uncompensated system performance in terms of symbol error rates is significantly degraded. The scheme is designed to remove these IQ distortions in combination with the linear distortions, introduced by the transmission channel, individually for each subcarrier of a multicarrier system. The scheme relies on the existence of interspersed training symbols at subcarrier level (pilot carriers).

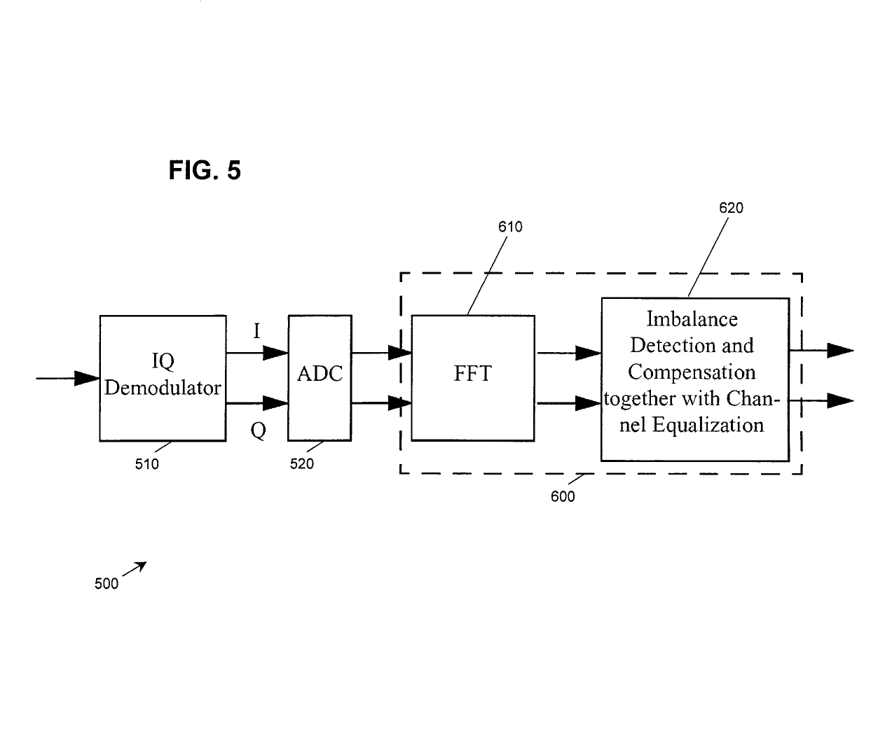

The novel IQ compensation scheme takes into account that in a multicarrier system most of the baseband signal processing takes place in the frequency domain and is based on the simple and cost-effective structure depicted in FIG. 5, where the complete compensation process is performed after the frequency domain transform. This reduces the number of expensive chip-external analogue components or at least allows the use of less-expensive components and therefore leads to cost savings in the overall system design and system manufacturing. As shown in FIG. 5, the IQ demodulator arrangement 500 includes an IQ demodulator stage 510, an analogue-to-digital converter 520, and an OFDM demodulator stage 600 which (as will be described in greater detail below) includes an FFT stage 610 and an extended adaptive frequency domain equalization stage 620 providing imbalance detection and compensation together with channel equalization.

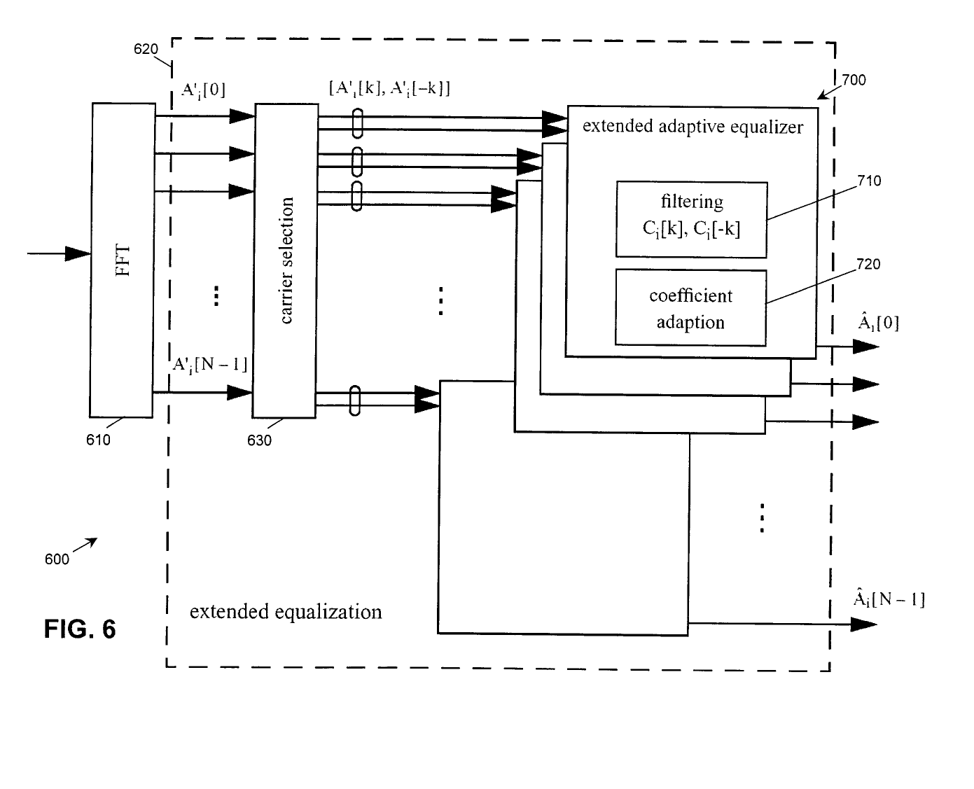

Referring now to FIG. 6, it will be seen that in the OFDM demodulator stage 600 the extended adaptive frequency domain equalization arrangement 620 includes (in place of the bank of single multipliers 420 and the estimation unit 430 of FIG. 4) a carrier select stage 630 and a bank of extended adaptive equalizer blocks 700. The carrier select stage provides, for each of the distorted desired subcarrier signals A′ᵢ[k] from the FFT 610, a pair of signals: the distorted desired subcarrier A′ᵢ[k] as well as the distorted image subcarrier A′ᵢ[−k]. Each of the extended adaptive equalizer blocks 700 includes a filtering stage 710 and a coefficient adaption stage 720.

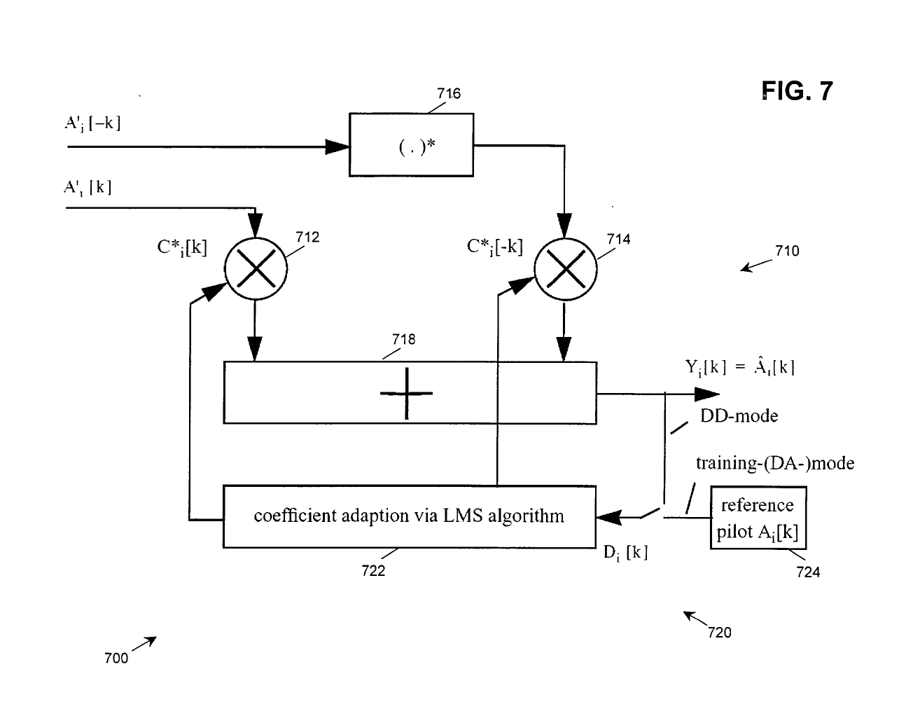

Referring now also to FIG. 7, in each of the extended equalizer blocks 700 of FIG. 6 the filtering stage 710 consists of a two-multiplier network 712 and 714. The multipliers 712 and 714 receive respectively as inputs the distorted desired subcarrier signal A′ᵢ[k] and the distorted image subcarrier signal A′ᵢ[−k] (via complex conjugator 716) from the carrier selection stage 630, and their outputs are summed at block 718 to calculate the undistorted desired subcarrier while removing both the linear and the IQ interference components.

The required filter coefficents Cᵢ[k], Cᵢ[−k] for the multipliers 712 and 714 are iteratively adapted by an adaptation algorithm at block 722 that minimizes the mean-square error between the reference/desired value and the calculated one. The LMS-algorithm was chosen for its simplicity.

By selecting a pilot subcarrier as input signal A′ᵢ[k] and using the undistorted pilot Aᵢ[k] as reference signal Dᵢ[k] (supplied at block 724) the equalizer is trained (in a data-aided—DA—adaptation phase). The coefficient adaptation is performed in block 722 via the LMS (least mean square) algorithm. During this phase the filter coefficients Cᵢ[k] and Cᵢ[−k] can be adapted for all pilot positions, where, according to the specified pilot pattern, a pilot subcarrier is mapped on a data carrier by flipping the subcarrier indexes, i.e., flipping the DFT vector (it can be shown that this mapping condition is necessary for the convergence of the LMS-algorithm.). After the training phase, when the filter coefficients are sufficiently settled, the data subcarriers at all positions between the previously calculated ones are estimated by switching to a decision-directed (DD−) mode.

The coefficients calculated in this way serve as initialisation for neighbouring frequency indexes. In this mode, in which the symbol decisions are reliable enough, the mapping condition does not need to be fulfilled.

It will be understood that instead of training coefficients based on DVB-T pilot symbols in the IQ signals, different training symbols (in a different system) may be used. Alternatively, if desired, blind adaptation of the equalizer network, i.e., without any training/pilot information, may be used.

It will be understood that the frequency domain compensation scheme for OFDM signals with IQ imbalance described above provides the following advantages:

1. Complexity in analog circuitry (i.e., costs) can be reduced at the expense of additional digital signal processing. This yields an overall economic system solution. In particular, the invention can speed up the application of cost-effective direct conversion receiver concepts in bandwidth efficient broadband communication systems based on OFDM with high-order signal constellations (e.g. 64 quadrature amplitude modulation for digital TV).

2. The FFT stage 610 in FIG. 5 and FIG. 6 can be supplied by re-use of the FFT-modules which are already implemented in all known OFDM demodulators, keeping low the amount of additional digital signal processing required.

3. The invention can be easily applied to existing systems. In the preferred embodiment described above, compliance with the DVB-T standard is maintained. In particular, no changes to installed broadcasting infrastructure are necessary to support receivers employing the novel compensation scheme.

4. The invention can be implemented as a simple extension to existing demodulator architectures: no interaction with other modules of the receiver system is required, especially no feedback loop to the tuner section.

5. The invention adapts automatically to the IQ imbalances from the tuner. No extra calibration is necessary.

6. Linear distortions from radio channels and distortions from tuner generated IQ imbalances are compensated simultaneously, in a simple manner without requiring further processing or circuitry.

7. Although described above in the context of a DVB-T system, the invention is not restricted to such systems and can be applied generally to all OFDM-based communications systems. Further, although described above in the context of a radio communication system, the invention is not restricted to such systems and can be applied generally to all communication systems, including wired communication systems.

It will be understood that the arrangement and method for frequency domain compensation of OFDM signals with IQ imbalance described above will typically be fabricated in an integrated circuit, for example an OFDM TV demodulator IC (not shown).

In summary, it will be understood that frequency domain IQ imbalance compensation scheme described above solves the IQ imbalance problem caused by inaccuracies in analogue RF quadrature demodulators (IQ demodulators) in combination with multicarrier transmission. Applied to data-aided (pilot-assisted) OFDM signal transmission the scheme compensates amplitude and phase imbalance generated in the analog downconversion process. If this kind of interference remains uncompensated the system performance in terms of symbol error rates is significantly degraded. The scheme removes these IQ distortions in combination with the linear distortions, introduced by the transmission channel, individually for each subcarrier of a multicarrier system.

It will be further appreciated that other alternatives to the embodiment of the invention described above will be apparent to a person of ordinary skill in the art.

1. An arrangement for frequency domain compensation of OFDM signals with IQ imbalance, the arrangement comprising:
FFT means for converting IQ signals to the frequency domain; and
imbalance compensation and channel equalization means for, in the frequency domain, compensating for IQ imbalance in the IQ signals and providing channel equalization thereto.

2. The arrangement of claim 1 wherein the imbalance compensation and channel equalization means comprise:
a plurality of filter means each arranged for filtering signals representative of a respective one of a plurality of subcarriers in the IQ signals and of an image thereof; and
coefficient means coupled to the filter means for deriving from the IQ signals coefficients for use by the filter means.

3. The arrangement of claim 2 wherein the plurality of filter means each comprise:
a first multiplier for multiplying the signal representative of a respective one of a plurality of subcarriers in the IQ signals with a first coefficient;
a second multiplier for multiplying the signal representative of an image of the respective one of a plurality of subcarriers in the IQ signals with a second coefficient; and
summing means for summing the outputs of the first and second multipliers.

4. The arrangement of claim 2 wherein the coefficient means comprises a plurality of adaption means each coupled to a respective one of the plurality of filter means, the adaption means each being arranged to adapt the coefficients by reduction of a difference between a reference signal and the output of the filter means.

5. The arrangement of claim 4 wherein the reference signal is derived from pilot signals present in the IQ signals.

6. The arrangement of claim 4 wherein the reference signal is derived from the output of the filter means.

7. The arrangement of claim 4 wherein the adaption means are each arranged to adapt the coefficients by least mean square calculation.

8. The arrangement of claim 1 wherein the IQ signals are digital television signals.

9. The arrangement of claim 8 wherein the signals are DVB-T signals.

10. An IQ demodulator arrangement comprising the arrangement of claim 1.

11. An integrated circuit comprising the arrangement of claim 1.

12. A communication system receiver comprising the arrangement of claim 1.

13. A method for frequency domain compensation of OFDM signals with IQ imbalance, the method comprising:
converting IQ signals to the frequency domain; and
providing imbalance compensation and channel equalization means and therewith, in the frequency domain, compensating for IQ imbalance in the IQ signals and providing channel equalization thereto.

14. The method of claim 13 wherein the imbalance compensation and channel equalization means comprise:
a plurality of filter means each filtering signals representative of a respective one of a plurality of subcarriers in the IQ signals and of an image thereof; and
coefficient means coupled to the filter means deriving from the IQ signals coefficients used by the filter means.

15. The method of claim 14 wherein the plurality of filter means each comprise:
a first multiplier multiplying the signal representative of a respective one of a plurality of subcarriers in the IQ signals with a first coefficient;
a second multiplier multiplying the signal representative of an image of the respective one of a plurality of subcarriers in the IQ signals with a second coefficient; and
summing means summing the outputs of the first and second multipliers.

16. The method of claim 14 wherein the coefficient means comprises a plurality of adaption means each coupled to a respective one of the plurality of filter means, the adaption means each adapting the coefficients by reduction of a difference between a reference signal and the output of the filter means.

17. The method of claim 16 wherein the reference signal is derived from pilot signals present in the IQ signals.

18. The method of claim 16 wherein the reference signal is derived from the output of the filter means.

19. The method of claim 16 wherein the adaption means each adapt the coefficients by least mean square calculation.

20. The method of claim 13 wherein the IQ signals are digital television signals.

21. The method of claim 20 wherein the signals are DVB-T signals.
